(19) United States
(12) Patent Application Publication
(10) Pub. No.: US 2024/0241000 A1
(43) Pub. Date: Jul. 18, 2024

(54) CONTACT SENSOR WITH FAILURE DETECTION MECHANISM

(71) Applicant: MECHAVISION INC., Taipei City (TW)

(72) Inventors: CHANG-HO LIOU, Hsinchu City (TW); JUI-YIAO SU, New Taipei City (TW); YUAN-LI LU, New Taipei City (TW)

(21) Appl. No.: 18/253,927

(22) PCT Filed: Nov. 23, 2020
(86) PCT No.: PCT/CN2020/130875

§ 371 Date: Oct. 18, 2023

(51) Int. Cl. G01L 1/18

(52) U.S. Cl. CPC G01L 1/18

(57) ABSTRACT

A contact sensor includes two film layers, two electrode layers, and a failure detection electrode. The two film layers respectively have a first inner surface and a second inner surface corresponding to each other. The two electrode layers are respectively disposed on the first inner surface and the second inner surface, and the two electrode layers are separated by a gap. The failure detection electrode is disposed on at least one of the first inner surface and the second inner surface and is electrically isolated from the two electrode layers.

### CROSS-REFERENCE TO RELATED APPLICATION

This application is the US national phase of international application No. PCT/CN2020/130875 filed on Nov. 23, 2020, the entire contents of which are hereby incorporated by reference.

### BACKGROUND OF THE INVENTION

### 1. Field of the Invention

The present disclosure relates to a contact sensor, and in particular to a contact sensor with a failure detection mechanism.

### 2. Description of the Related Art

With the development of automated equipment, the safety of automated equipment has also received attention. For example, safety mechanisms for collaboration robots have become an important issue due to the close collaboration with human operators. In recent years, the International Standards Organization has published ISO/TS 15066, which sets out further safety specifications for collaboration robots in robotic devices.

A contact detection mechanism is one of the safety mechanisms for automated equipment. With the addition of a contact detection mechanism, automated equipment can make emergency actions when the contact detector detects contact events from human operators. Refer to FIG. 1 which is a drawing illustrating a conventional automated system 1 having a contact detection mechanism in a collaboration robot system. The automated system 1 includes a controller 11, a movable member 12, a contact sensor 13, and a signal line 14. The movable member 12 is a movable robotic arm of the collaboration robot system, which can be controlled by the controller 11 for movement. The contact sensor 13 is disposed on the movable member 12, and electrically connected to the controller 11 by the signal line 14.

However, the contact sensor can fail due to poor quality during the manufacturing process or the material aging over time and thus the contact sensor cannot instantaneously exchange signals with the controller. Communication failure will greatly reduce the safety of the automated equipment, and may even cause injury to operators. Therefore, how to know as early as possible that the contact sensor can or cannot exchange signals with the controller is an important technical and safety issue.

### BRIEF SUMMARY OF THE INVENTION

An objective of the present disclosure is to provide a contact sensor with a failure detection mechanism, which can identify failures of signal exchanges between the contact sensor and the controller in advance.

According to an embodiment of the present disclosure, a contact sensor comprises two film layers, two electrode layers, two failure detection electrodes, and a conductive connecting portion. The two film layers respectively have a first inner surface and a second inner surface corresponding to each other. The two electrode layers are respectively disposed on the first inner surface and the second inner surface, and the two electrode layers are separated by a gap. The failure detection electrode is disposed on at least one of the first inner surface and the second inner surface, and is electrically isolated from the two electrode layers.

In an embodiment, the contact sensor may further include a sensing layer disposed on one of the two electrode layers. The sensing layer may include a pressure sensitive material, and the pressure sensitive material includes at least one conductive substance. The contact sensor may also include a gap layer, which is disposed between the two film layers to form a gap between the two electrode layers.

In an embodiment, the contact sensor may further include two signal ends and two detection ends. The two signal ends are respectively electrically connected to the two electrode layers, and the two detection ends are respectively electrically connected to the failure detection electrode. The contact sensor may also include a toggle switch with one end connected to the signal line and the other end selectively connected to the two signal ends or the two detection ends.

### BRIEF DESCRIPTION OF THE DRAWINGS

FIG. 1 is a schematic view illustrating a conventional automated system with a contact detection mechanism according to the prior art.

FIG. 2 is a schematic view illustrating a contact sensor of an embodiment of the present disclosure.

FIG. 3 is a schematic perspective view illustrating the perspective structure of the contact sensor shown in FIG. 2.

FIG. 4 is a schematic view illustrating a contact sensor of an embodiment of the present disclosure.

FIG. 5 is a schematic perspective view illustrating the perspective structure of the contact sensor shown in FIG. 4.

FIG. 6 is a schematic view illustrating a connection between a contact sensor, a toggle switch, and a signal line according to an embodiment of the present disclosure.

FIG. 7 is schematic diagram illustrating a contact sensor according to an embodiment of the present disclosure.

FIG. 8 is schematic diagram illustrating a contact sensor according to an embodiment of the present disclosure.

### REFERENCE SYMBOLS

1 conventional automated system
11 controller
12 movable member
13 contact sensor
14 signal line
23 contact sensor
23′ contact sensor
23o signal end
23i signal end
23fo detection end
23fi detection end
231a film layer
231b film layer
231af first inner surface
231bf second inner surface
232a electrode layer
232b electrode layer
233a sensing layer
233b sensing layer
234 gap layer
235 failure detection electrode
235a sub-failure detection electrode
235b sub-failure detection electrode
235c conductive connecting portion
236 failure detection electrode
236a failure detection electrode
236b failure detection electrode
236c conductive connecting portion
41 toggle switch
53 contact sensor
53′ contact sensor
531a film layer
531b film layer
532a electrode layer
532b electrode layer
535a failure detection electrode
535b failure detection electrode
535c conductive connecting portion
536a sub-failure detection electrode
536b sub-failure detection electrode
536c conductive connecting portion
G gap

### DETAILED DESCRIPTION OF THE INVENTION

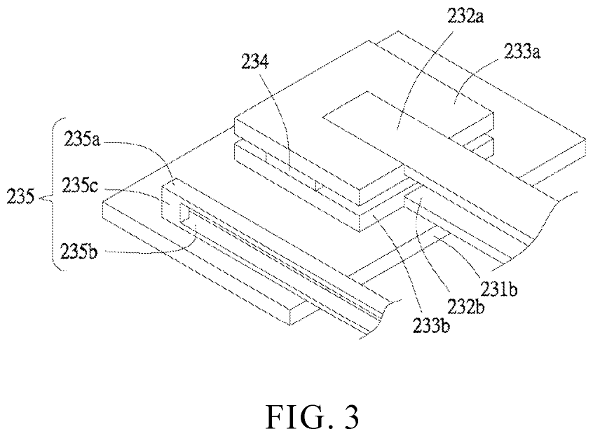

Referring to FIGS. 2 and 3, a contact sensor 23 according to an embodiment of the present disclosure comprises two film layers 231a and 231b, two electrode layers 232a and 232b, two sensing layers 233a and 233b, a gap layer 234 and a failure detection electrode 235 including two sub-failure detection electrodes 235a and 235b and a conductive connecting portion 235c. FIG. 3 is a schematic perspective view of the structure shown in FIG. 2, wherein the film layer 231a in FIG. 2 is removed in FIG. 3 to more clearly show the internal structure of the contact sensor 23.

The two film layers 231a and 231b respectively have a first inner surface 231af and a second inner surface 231bf corresponding to each other. The two electrode layers 232a and 232b are respectively disposed on the first inner surface 231af and the second inner surface 231bf corresponding to each other, and separated by a gap G. The two sensing layers 233a and 233b are respectively disposed on the corresponding electrode layers 232a and 232b. The gap layer 234 is formed between the two film layers 231a and 231b, so that the gap G remains between the two electrode layers 232a and 232b. The two sensing layers 233a and 233b may be a pressure sensitive material including a conductive substance and are formed on the two electrode layers 232a and 232b by coating or printing.

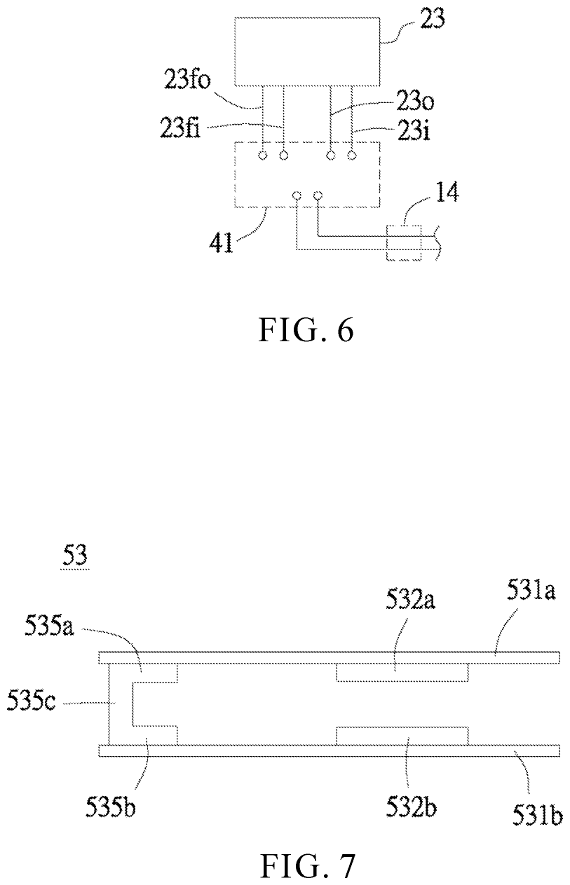

When the film layer 231a is contacted, it will be deformed by pressure, so that a distance between the two electrode layers 232a and 232b becomes shorter. The pressure sensitive materials of the sensing layers 233a and 233b are subjected to pressure so that the conductive substances in the pressure sensitive material are in contact, and a conductive path is formed between the two electrode layers 232a and 232b. The electrode layers 232a and 232b are respectively connected to two signal ends 23o and 23i (as shown in FIG. 6). If the conductive path is formed between the two electrode layers 232a and 232b due to contact, the voltage received by the signal end 23i may be output from the signal end 23o to a controller of an automation system as a contact signal.

The two sub-failure detection electrodes 235a and 235b are respectively disposed on the first inner surface 231af and the second inner surface 231bf corresponding to each other, and are electrically isolated from the two electrode layers 232a and 232b. That is, the two sub-failure detection electrodes 235a and 235b are not electrically connected to the two electrode layers 232a and 232b, nor are they electrically connected to the two sensing layers 233a and 233b disposed on the two electrode layers 232a and 232b. The two sub-failure detection electrodes 235a and 235b are provided with the conductive connecting portion 235c to establish an electrical connection, and the two sub-failure detection electrodes 235a and 235b are respectively connected to two detection ends 23fo and 23fi (as shown in FIG. 6).

The structure shown in FIGS. 2 and 3 may result in the two film layers 231a and 231b peeling away from each other because of poor quality of the manufacturing process, or the material aging over time. The peeling of the film layers 231a and 231b will cause the gap G between the two electrode layers 232a and 232b to become larger, so that when the film layer 231a is contacted, the establishment of an electrical connection between the electrode layers 232a and 232b becomes difficult. This causes the contact sensor to fail and any contact cannot be detected. By the design of the present disclosure, operators can connect the detection ends 23fo and 23fi (FIG. 6) to detect whether either of the film layers has peeled off. That is, the operators can apply a voltage to the detection end 23fi, and detect whether the detection end 23fo has a voltage output. When the film layers 231a and 231b haven't peeled off, the conductive connecting portion 235c can establish an electrical connection between the sub-failure detection electrodes 235a and 235b, so that the detection end 23fo outputs a voltage. If either of the film layers 231a or 231b have peeled off, the conductive connecting portion part 235c will be disconnected which will result in the sub-failure detection electrodes 235a and 235b not being able to establish an electrical connection. In this case, the detection end 23fo fails to output a voltage. Therefore, by detecting whether the detection end 23fo has a voltage output, it can be known whether either of the film layers 231a or 231b have peeled off. In an embodiment, the voltage received by the detection end 23fi may be output from the detection end 23fo to the controller of the automation system, and the present disclosure is not limited thereto.

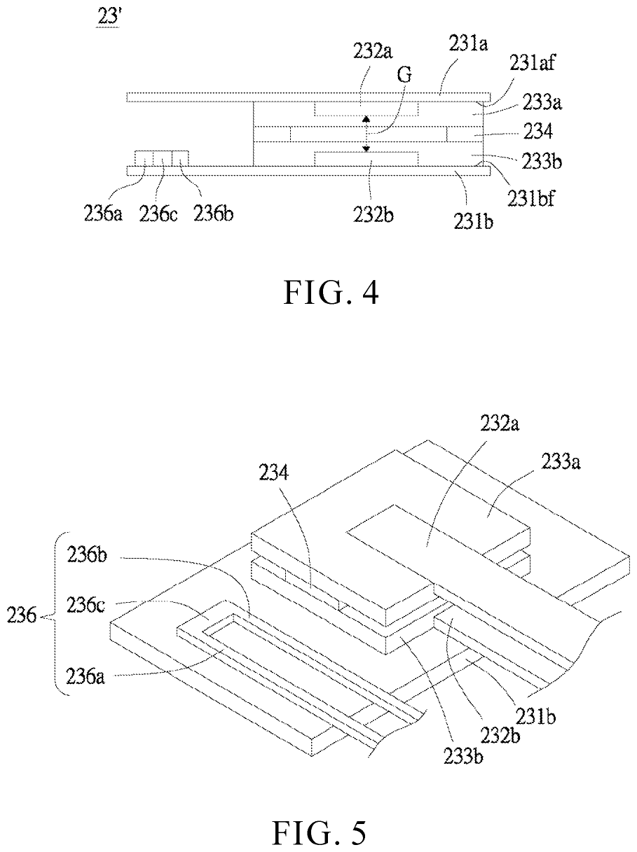

Refer to FIGS. 4 and 5, which illustrate a contact sensor 23′ according to an embodiment of the present disclosure. Reference numerals in FIGS. 4 and 5 that are the same as those in FIGS. 2 and 3 are the same elements, so they will not be repeated herein. FIGS. 4 and 5 differ from FIGS. 2 and 3 in that the contact sensor 23′ includes a failure detection electrode 236, which includes two sub-failure detection electrodes 236a and 236b, and a conductive connecting portion 236c. The two sub-failure detection electrodes 236a and 236b are configured on the same inner surface, in this embodiment, the two sub-failure detection electrodes 236a and 236b are disposed on the second inner surface 231bf. In another embodiment, the two sub-failure detection electrodes 236a and 236b may also be configured on the first inner surface 231af (not depicted), and the present disclosure is not limited thereto.

The two sub-failure detection electrodes 236a and 236b and the two electrode layers 232a and 232b are electrically isolated, and the two sub-failure detection electrodes 236a and 236b are provided with the conductive connecting portion 236c to establish an electrical connection between the two sub-failure detection electrodes 236a and 236b. The two sub-failure detection electrodes 236a and 236b are respectively connected to two detection ends 23fo and 23fi (as shown in FIG. 6).

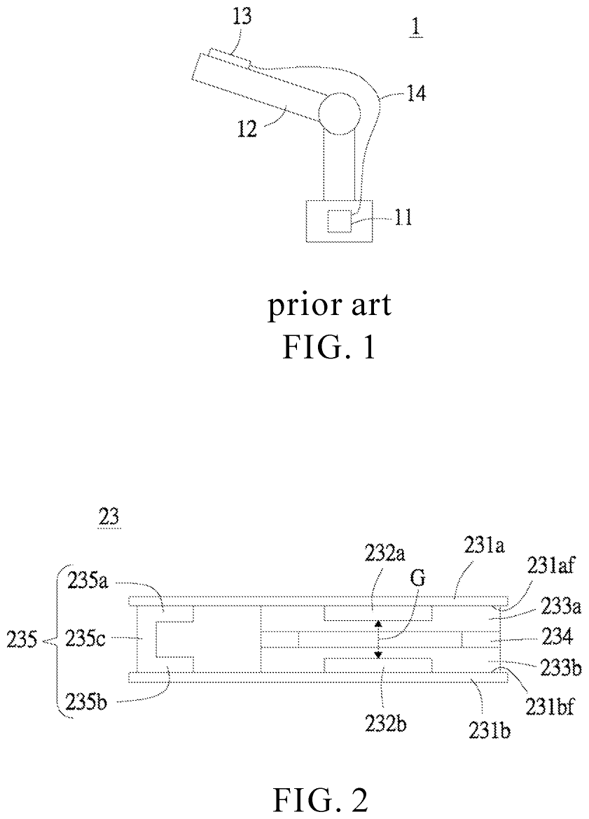

The contact sensor 23′ shown in FIG. 4 and FIG. 5 is connected to the controller 11 via a signal line 14 for communication (as shown in FIG. 1). However, the signal line 14 may result in poor signal transmission or disconnection because of poor quality of the manufacturing process, or the material aging over time, which causes signal transmission failure and the controller 11 cannot receive the signal transmitted by the contact sensor 23′. By the design of the present disclosure, operators can connect the detection ends 23fo and 23fi to detect whether the signal line 14 is damaged. That is, the operators can apply a voltage to the detection end 23fi, and detect whether the detection end 23fo has a voltage output. In the case of no damage to the signal line 14, the conductive connecting portion 236c can establish an electrical connection between the sub-failure detection electrodes 236a and 236b, so that the detection end 23fo outputs a voltage. If the signal line 14 is damaged, the voltage cannot be transmitted from the detection end 23fi to the detection end 23fo. In this case, the detection end 23fo fails to output a voltage. Therefore, by detecting whether the detection end 23fo has a voltage output, it can be known whether the signal line 14 is damaged. In an embodiment, the voltage received by the detection end 23fi may be output from the detection end 23fo to the controller of the automation system, and the present disclosure is not limited thereto.

Referring to FIG. 6, in an embodiment, a toggle switch 41 may be connected between a signal line 14 having two wires, two signal ends 23o and 23i, and two detection ends 23fo and 23fi, so that the signal line 14 can optionally connect to the two signal ends 23o and 23i or the two detection ends 23fo and 23fi. In a normal operating mode, the toggle switch 41 can connect the two wires of the signal line 14 and the two signal ends 23o and 23i to detect whether there is contact. In a failure detection mode, the toggle switch 41 can be switched to connect the two wires of the signal line 14 and the detection ends 23fo and 23fi to detect whether the signal exchange (i.e., voltage transmission) fails. This allows the operators to easily switch between the normal operation mode and the failure detection mode, greatly improving the convenience of operation.

It should be noted that those skilled in the art may make various changes and modifications to the above embodiments without departing from the spirit and scope of the present disclosure. For example, referring to FIG. 7, the contact sensor 53 according to an embodiment of the present disclosure includes two film layers 531a and 531b, two electrode layers 532a and 532b, two sub-failure detection electrodes 535a and 535b, and a conductive connecting portion 535c. In contrast to the embodiments shown in FIGS. 2 and 3, the contact sensor 53 shown in FIG. 7 does not include a sensing layer and a gap layer. When the film layer 531a is contacted, it will be deformed by pressure, so that the two electrode layers 532a and 532b are in contact, forming a conductive path between the two electrode layers 532a and 532b, so that the contact sensor 53 can output a contact signal.

In the present embodiment, the operating principle of the two failure detection electrodes 535a and 535b and the conductive connecting portion 535c is the same as the embodiments shown in FIGS. 2 and 3. When either of the film layers 531a or 531b hasn't peeled off, the conductive connecting portion 535c can establish an electrical connection between the sub-failure detection electrodes 535a and 535b. If either of the film layers 531a and 531b has peeled off, the conductive connecting portion 535c will be disconnected which results in that the sub-failure detection electrodes 535a and 535b cannot establish an electrical connection. Therefore, by detecting whether the detection end connected to the failure detection electrode has a voltage output, it can be known whether either of the film layers has peeled off.

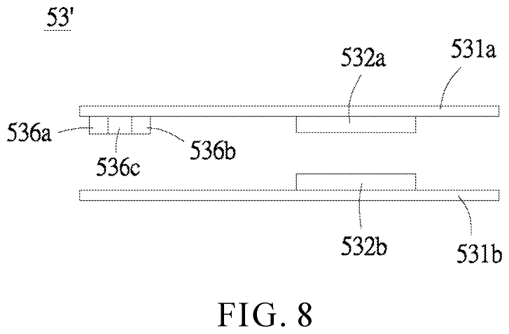

Refer to FIG. 8, which is a contact sensor 53′ according to an embodiment of the present disclosure. Reference numerals in FIG. 8 that are the same as those in FIG. 7 are the same elements, so they will not be repeated herein. FIG. 8 differs from FIG. 7 in that the contact sensor 53′ includes two sub-failure detection electrodes 536a and 536b and a conductive connecting portion 536c. The two failure detection electrodes 236a and 236b are configured on the same inner surface and the operating principle is the same as the embodiments shown in FIGS. 4 and 5. When there is damage to the signal line 14, a voltage may be input from the detection end 23fi, and output to the detection end 23fo through the two sub-failure detection electrodes 536a and 536b and the conductive connecting portion 536c. If the signal line 14 is damaged, the voltage will not be output to the detection end 23fo through the two sub-failure detection electrodes 536a and 536b and the conductive connecting portion 536c. Therefore, by detecting whether the detection ends 23fi, 23fo (as shown in FIG. 6) connected to the sub-failure detection electrodes 536a and 536b have a voltage output, it can be known whether the signal line 14 is damaged.

Therefore, the contact sensor provided in the present disclosure can quickly detect whether the contact sensor can communicate normally with the controller and electrically connect to exchange signals by detecting the detection end connected to the failure detection electrode, so as to enhance the convenience of the contact sensor when using.

In summary, although the present invention has been disclosed as above by the embodiments, it is not intended to limit the present invention. Various changes and modifications may be made by those skilled in the art without departing from the spirit and scope of the present invention. Therefore, the protection scope of the present invention shall be defined by the attached claims.

What is claimed is:

1. A contact sensor, comprising:
two film layers, respectively having a first inner surface and a second inner surface corresponding to each other;
two electrode layers, respectively disposed on the first inner surface and the second inner surface and the two electrode layers are separated by a gap; and
a failure detection electrode, disposed on at least one of the first inner surface and the second inner surface and is electrically isolated from the two electrode layers.

2. The contact sensor according to claim 1, further comprising:
a sensing layer disposed on one of the two electrode layers.

3. The contact sensor according to claim 2, wherein the sensing layer comprises a pressure sensitive material, the pressure sensitive material comprises at least one conductive substance therein.

4. The contact sensor according to claim 1, further comprising:
a gap layer, disposed between the two film layers, so that the gap is formed between the two electrode layers.

5. The contact sensor according to claim 1, wherein the failure detection electrode comprises:
two sub-failure detection electrodes disposed on at least one of the first inner surface and the second inner surface; and
a conductive connecting portion electrically connected to the two sub-failure detection electrodes.

6. The contact sensor according to claim 1, wherein the failure detection electrode comprises:
two sub-failure detection electrodes respectively disposed on the first inner surface and the second inner surface; and
a conductive connecting portion electrically connected to the two sub-failure detection electrodes.

7. The contact sensor according to claim 5, further comprising:
two signal ends respectively electrically connected to the two electrode layers; and
two detection ends respectively electrically connected to the two sub-failure detection electrodes.

8. The contact sensor according to claim 7, further comprising:
a toggle switch with one end connected to the signal line and the other end selectively connected to the two signal ends or the two detection ends.
